(19) United States
(12) Patent Application Publication
(10) Pub. No.: US 2026/0001169 A1
(43) Pub. Date: Jan. 1, 2026

(54) MODIFIED OBJECT AND MANUFACTURING METHOD THEREOF

(71) Applicant: GlobalWafers Co., Ltd., Hsinchu (TW)

(72) Inventors: Chung-Wei Cheng, Hsinchu (TW); Ying-Ru Shih, Hsinchu (TW); Jia-Fan Kuo, Hsinchu (TW); Bo-Kai Wang, Hsinchu (TW)

(73) Assignee: GlobalWafers Co., Ltd., Hsinchu (TW)

(21) Appl. No.: 19/201,810

(22) Filed: May 7, 2025

(30) Foreign Application Priority Data
Jun. 26, 2024 (TW) 113123811

(51) Int. Cl. B23K 26/53; B23K 26/0622; B23K 103/00

(52) U.S. Cl. CPC B23K 26/53; B23K 26/0624; B23K 2103/56

(57) ABSTRACT

A modified object includes a single crystal substrate, an internal modification trace and a surface processing trace. The single crystal substrate has a first surface and a second surface facing away from the first surface. The first surface and the second surface of the single crystal substrate are arranged in a thickness direction of the single crystal substrate. The internal modification trace is formed between the first surface and the second surface of the single crystal substrate. The surface processing trace are formed on the second surface of the single crystal substrate. The internal modification trace and the surface processing trace overlap in the thickness direction of the single crystal substrate. In addition, a method for manufacturing the modified object is also provided.

### CROSS-REFERENCE TO RELATED APPLICATION

This application claims the priority benefit of Taiwan application serial no. 113123811, filed on Jun. 26, 2024. The entirety of the above-mentioned patent application is hereby incorporated by reference herein and made a part of this specification.

### BACKGROUND

### Technical Field

This disclosure relates to a modified object and a method for manufacturing the same.

### Description of Related Art

Silicon carbide is a notable example of a single crystal material that has great industrial application value and is relatively difficult to cut mechanically. Silicon carbide single crystal wafers can be used to make transistors for applications such as electric vehicles or power conversion because of their suitability for high temperature and high voltage. As far as the existing technology is concerned, wafer warpage is easily caused by heteroepitaxial lattice mismatch. How to effectively control wafer warpage in advance is an important issue that needs to be improved. In addition, the wafer has the problem of heating up too quickly during epitaxial growth, so how to control the temperature rise is another important issue that needs to be improved.

### SUMMARY

This disclosure provides a method for manufacturing a modified object, which can control the bow value of the modified object.

This disclosure provides a modified object whose bow value can be controlled.

The method for manufacturing the modified object of the disclosure comprises following steps: providing an object to be modified, wherein the object to be modified comprises a single crystal material, the object to be modified has a first surface and a second surface facing away from the first surface, and the first surface and the second surface of the object to be modified are arranged in a thickness direction of the object to be modified; and using a laser beam to form a laser spot on the first surface of the object to be modified, and using the laser spot to scan the object to be modified along a predetermined track on the first surface of the object to be modified during a scanning period, so as to form an internal modification trace between the first surface and the second surface of the object to be modified, and form a surface processing trace on the second surface of the object to be modified.

The modified object of this disclosure includes a single crystal substrate, an internal modification trace and a surface processing trace. The single crystal substrate has a first surface and a second surface facing away from the first surface. The first surface and the second surface of the single crystal substrate are arranged in the thickness direction of the single crystal substrate. The internal modification trace is formed between the first surface and the second surface of the single crystal substrate. The surface processing trace is formed on the second surface of the single crystal substrate. The internal modification trace overlaps with the surface processing trace in the thickness direction of the single crystal substrate.

Based on the above, in the manufacturing method of the modified object of the present disclosure, a laser beam is scanned over the object to be modified within a single scanning period to form an internal modification trace inside the object to be modified and a surface processing trace is formed on a second surface of the object to be modified to complete the modified object. Through the internal modification trace, stress adjustment can be performed internally to correct the bow value of the modified object. Through the surface processing trace, the temperature distribution of the modified object can be controlled when it is heated up.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A to FIG. 1B are cross-sectional schematic diagrams of a manufacturing process of a modified object according to an embodiment of the disclosure.

FIG. 2A to FIG. 2B are top and perspective views of the manufacturing process of the modified object of the disclosure in one embodiment.

FIG. 3 shows the transmission of a laser beam in an object to be modified according to an embodiment of the disclosure.

FIG. 4 is a photograph of a cross section of a modified object according to an embodiment of the disclosure, taken using an electron microscope.

FIG. 5 is a top view of various internal modification traces of a modified object according to an embodiment of the disclosure, taken using an electron microscope.

FIG. 6 is a bottom-up photograph of various surface processing traces of a modified object according to an embodiment of the disclosure, taken using an electron microscope.

FIG. 7 is a bottom-up and enlarged schematic diagram of a surface processing trace according to an embodiment of the disclosure.

FIG. 8 shows a DRT curve of a modified object according to an embodiment of the disclosure and a DRT curve of a modified object according to a comparative example.

FIG. 9 shows a DRT curve of a modified object of the first embodiment and a DRT curve of a modified object of the second embodiment of the disclosure.

FIG. 10 shows a DRT curve of a modified object according to the third embodiment and a DRT curve of a modified object according to the fourth embodiment of the disclosure.

FIG. 11 shows the DRT curve of the modified object of the fifth embodiment and the DRT curve of the modified object of the sixth embodiment of the disclosure

FIG. 12 shows a DRT curve of a modified object according to the seventh embodiment and a DRT curve of a modified object according to the eighth embodiment of the disclosure.

### DESCRIPTION OF THE EMBODIMENTS

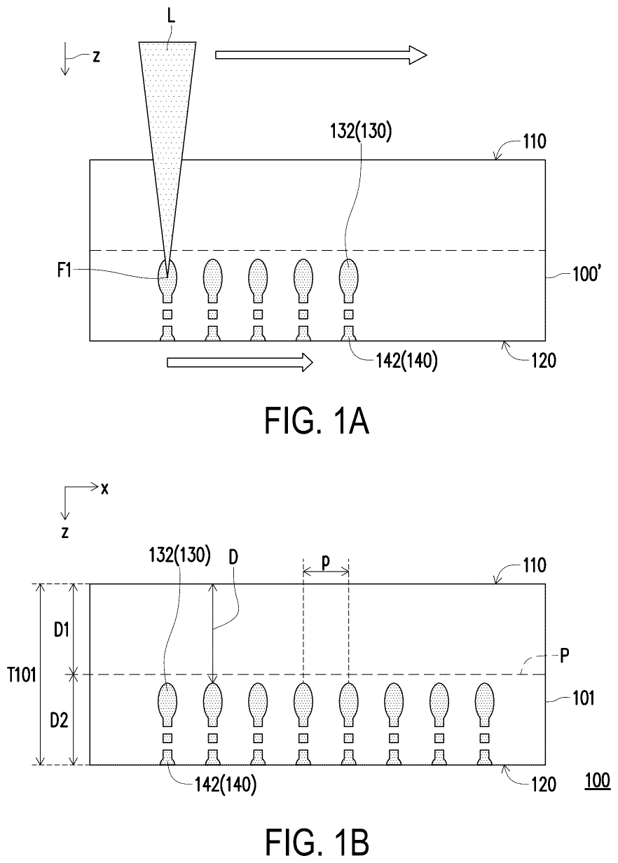

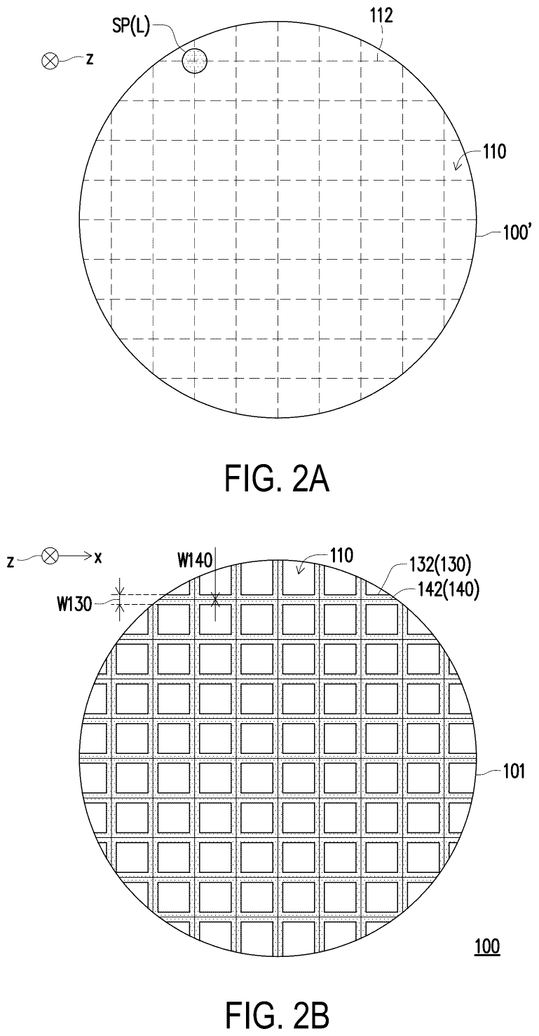

FIG. 1A to FIG. 1B are cross-sectional schematic diagrams of a manufacturing process of a modified object according to an embodiment of the disclosure. FIG. 2A to FIG. 2B are top and perspective views of the manufacturing process of the modified object of the disclosure in one embodiment.

Referring to FIG. 1A and FIG. 2A, first, an object to be modified 100′ is provided. The object to be modified 100′ has a first surface 110 and a second surface 120 facing away from the first surface 110. The first surface 110 and the second surface 120 of the object to be modified 100′ are arranged in the thickness direction z of the object to be modified 100′. The object to be modified 100′ includes a single crystal material. In some embodiments, the single crystal material includes, for example, silicon carbide, and the object to be modified 100′ is, for example, a silicon carbide wafer, but this disclosure is not limited thereto.

Referring to FIG. 1A and FIG. 2A, then, a laser beam L is used to form a laser spot SP on a first surface 110 of the object to be modified 100′. In some embodiments, the laser beam L forms a single laser spot SP on the first surface 110. In some embodiments, a first focal point F1 of the laser beam L falls between the first surface 110 and the second surface 120 of the object to be modified 100′. That is, the first focal point F1 of the laser beam L falls inside the object to be modified 100′.

A size of the first focal point F1 is related to a numerical aperture NA of the laser beam L, wherein

$$NA = \frac{{λ}_{0}}{{πω}_{0}} ,$$

λ₀ is a central wavelength of the laser beam L in vacuum, and ω₀ is a waist width of the laser beam L in vacuum. When the numerical aperture NA of the laser beam L is larger, the size of the first focal point F1 of laser beam L is smaller.

The central wavelength of the laser beam L is preferably selected to have high penetration rate (e.g. ≥80%) in the object to be modified 100′ and to be absorbed inside the object to be modified 100′. Under irradiation of the short-pulse, high-energy laser beam L, the object to be modified 100′ with a wide energy gap can achieve internal precision processing through multi-photon absorption. For example, in some embodiments, the object to be modified 100′ may include 4H-SiC, the material energy gap of 4H-SiC is 3.3 eV, and the photon energy of laser beam L is 1.204 eV, which is less than 3.3 eV of the material energy gap of 4H-SiC, that is, the central wavelength of laser beam L may be 1030 nm, but the disclosure is not limited thereto. In some embodiments, the central wavelength of laser beam L may be in a range of 500 nm to 1100 nm.

The laser beam L may be a short pulse laser to reduce the thermal effect on the object to be modified 100′ during the modification/processing process. For example, in some embodiments, the pulse width of the laser beam L may be in the femtosecond (fs) range, such as in the range of 10 fs to 5000 fs. However, the disclosure is not limited thereto, and in other embodiments, the pulse time of the laser beam L may be in another level, such as but not limited to: picosecond level, nanosecond level, etc.

Referring to FIG. 1A, FIG. 1B, FIG. 2A and FIG. 2B, then, within a scanning period, the laser spot SP is allowed to scan the object to be modified 100′ along a predetermined track 112 on the first surface 110 of the object to be modified 100′, so as to form an internal modification trace 130 between the first surface 110 and the second surface 120 of the object to be modified 100′, and form a surface processing trace 140 on the second surface 120 of the object to be modified 100′ within the scanning period. At this point, modified object 100 is completed.

The first surface 110 of the object to be modified 100′ is an incident surface for the laser beam L to be incident on. In some embodiments, the object to be modified 100′ includes SiC, for example, and the incident surface of the object to be modified 100′ may be a C surface or a Si surface. In some embodiments, if the object to be modified 100′ needs to be subjected to an epitaxial process after being modified, the incident surface of the object to be modified 100′ is preferably the C surface.

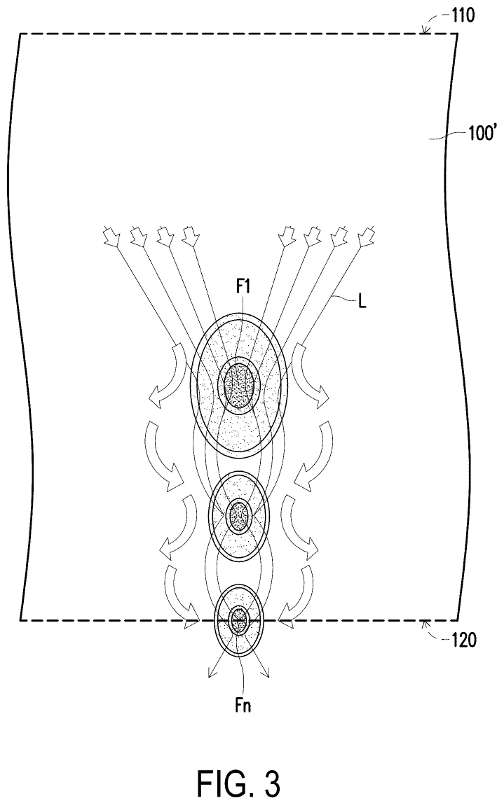

FIG. 3 shows the transmission of a laser beam in an object to be modified according to an embodiment of the disclosure. Referring to FIG. 1A, FIG. 1B, FIG. 2A, FIG. 2B and FIG. 3, in some embodiments, the internal modification trace 130 and the surface processing trace 140 are substantially formed simultaneously. In detail, in some embodiments, before using the laser beam L to scan the object to be modified 100′, working parameters of the laser beam L can be set first so that the first focal point F1 of the laser beam L falls between the first surface 110 and the second surface 120 of the object to be modified 100′, and the again focal point Fn of the laser beam L falls on the second surface 120 of the object to be modified 100′. In this way, when the laser spot SP scans the first surface 110 of the object to be modified 100′, the laser beam L can simultaneously form the internal modification trace 130 inside the object to be modified 100′ and the surface processing trace 140 on the second surface 120.

In some embodiments, the again focal point Fn of the laser beam L is formed because the short pulse width of the laser beam L can reach a high peak power, thereby causing the Kerr effect, causing the refractive index to change, resulting in defocusing and self-focusing phenomena.

In some embodiments, the set working parameter of the laser beam L may include at least one of the numerical aperture NA of the laser beam L and the pulse power of the laser beam L. For example, in some embodiments, the numerical aperture NA of the laser beam L may be in a range of 0.42-0.65, but the disclosure is not limited thereto. For example, in some embodiments, the pulse power of the laser beam L may be within a range of 0.1 W to 1.5 W, but the disclosure is not limited thereto. In some embodiments, if the pulse power of the laser beam L is too small (e.g., less than 0.1 W), the interior of the object to be modified 100′ cannot be effectively modified; if the pulse power of the laser beam L is too large (e.g., greater than 1.5 W), the first surface 110 of the object to be modified 100′ may be damaged.

The working parameters of the laser beam L may further include a pulse repetition rate of the laser beam L. For example, in some embodiments, the pulse repetition rate of the laser beam L may be in the range of 100 kHz to 1000 kHz, but the disclosure is not limited thereto.

The working parameters of the laser beam L may further include a scanning rate and a pulse repetition rate of the laser beam L. The pulse repetition rate of the laser beam L and the scanning rate of the laser beam L can be matched with each other to effectively form the internal modification trace 130 and the surface processing trace 140. For example, in one embodiment, the scanning rate of laser beam L may be in the range of 1.5 mm/s to 5 mm/s, and the pulse repetition rate of laser beam L may be 100 kHz; in another embodiment, the scanning rate of laser beam L may be in the range of 10 mm/s to 35 mm/s, and the pulse repetition rate of laser beam L may be 600 kHz; in yet another embodiment, the scanning rate of laser beam L may be within the range of 15 mm/s to 50 mm/s, and the pulse repetition rate of laser beam L may be 1000 kHz; however, this disclosure is not limited thereto.

Referring to FIG. 1B and FIG. 2B, the modified object 100 includes a single crystal substrate 101. The single crystal substrate 101 has a first surface 110 and a second surface 120 facing away from the first surface 110. The first surface 110 and the second surface 120 of the single crystal substrate 101 are arranged in the thickness direction z of the single crystal substrate 101. The single crystal substrate 101 includes a single crystal material. In some embodiments, the single crystal material includes, for example, silicon carbide, but the disclosure is not limited thereto.

The modified object 100 further includes an internal modification trace 130 and a surface processing trace 140. The internal modification trace 130 is formed between the first surface 110 and the second surface 120 of the single crystal substrate 101. That is, the internal modification trace 130 is formed inside the single crystal substrate 101. The surface processing trace 140 is formed on the second surface 120 of the single crystal substrate 101. In particular, the internal modification trace 130 and the surface processing trace 140 overlap in the thickness direction z of the single crystal substrate 101.

In some embodiments, the internal modification trace 130 may include sub-internal modification traces 132, and the sub-internal modification traces 132 are spaced apart from each other in a first direction x perpendicular to the thickness direction z. In some embodiments, the surface processing trace 140 may include sub-surface processing traces 142, and the sub-surface processing traces 142 are spaced apart from each other in a first direction x perpendicular to the thickness direction z. In some embodiments, the sub-internal modification traces 132 overlap with the sub-surface processing traces 142 in the thickness direction z of the single crystal substrate 101, respectively. In some embodiments, the sub-surface processing traces 142 may include grooves recessed in the second surface 120.

In some embodiments, the internal modification trace 130 has a first width W130 in a first direction x perpendicular to the thickness direction z, the surface processing trace 140 has a second width W140 in the first direction x perpendicular to the thickness direction z, and the second width W140 is smaller than the first width W130. In some embodiments, the first width W130 may refer to a width of a sub-internal modification trace 132 in the first direction x, and the second width W140 may refer to a width of a sub-surface processing trace 142 in the first direction x.

For example, in some embodiments, the first width W130 may be within a range of 10 μm to 30 μm, and the second width W140 may be within a range of 5 μm to 10 μm, but the disclosure is not limited thereto. The sizes of the first width W130 and the second width W140 depend on the working parameters of the laser beam L used to manufacture the modified object 100. When the pulse power of the laser beam L is greater, the first width W130 and the second width W140 are greater. When the scanning rate of the laser beam L is smaller, the first width W130 and the second width W140 are larger.

In some embodiments, a normal projection of the surface processing trace 140 falls within a normal projection of the internal modification trace 130. In some embodiments, a normal projection of each of the sub-surface processing traces 142 may fall within a normal projection of a corresponding sub-internal modification trace 132.

In some embodiments, the shape of the normal projection of the surface processing trace 140 is consistent with the shape of the normal projection of the internal modification trace 130. For example, in some embodiments, the normal projection of the surface processing trace 140 and the normal projection of the internal modification trace 130 may both be in a mesh shape. However, the disclosure is not limited thereto, and the shapes of the normal projections of the surface processing trace 140 and the internal modification trace 130 depend on the scanning trajectory of the laser beam L. In other embodiments, the normal projections of the surface processing trace 140 and the internal modification trace 130 may also be in other shapes, such as but not limited to: a plurality of concentric circles.

Referring to FIG. 1B, the dummy plane P is located between the first surface 110 and the second surface 120 of the single crystal substrate 101, there is a first distance D1 between the dummy plane P and the first surface 110 in the thickness direction z, there is a second distance D2 between the dummy plane P and the second surface 120 in the thickness direction z, and the first distance D1 is equal to the second distance D2. That is, the dummy plane P is a virtual dummy plane including the midline of the single crystal substrate 101.

In some embodiments, the internal modification trace 130 may be selectively located between the dummy plane P and the second surface 120. In other words, the internal modification trace 130 can selectively be located below the midline. However, the disclosure is not limited thereto. In other embodiments not shown, the internal modification trace 130 may also be selectively located at the midline or above the midline. In some embodiments, the thickness T101 of the single crystal substrate 101 in the thickness direction z may be 260 μm, and the distance D between the internal modification trace 130 and the first surface 110 may be in the range of 130 μm to 200 μm, but the disclosure is not limited thereto.

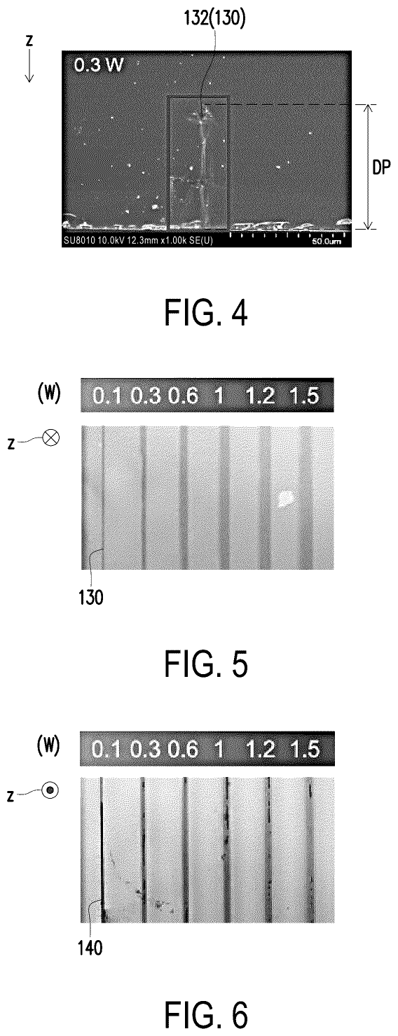

FIG. 4 is a photograph of a cross section of a modified object according to an embodiment of the disclosure, taken using an electron microscope. Referring to FIG. 1B, FIG. 2B and FIG. 4, the internal modification trace 130 of the modified object 100 has a depth DP in the thickness direction z. The internal modification trace 130 of the modified object 100 includes sub-internal modification traces 132, the sub-internal modification traces 132 are spaced apart from each other in a first direction x perpendicular to the thickness direction z, and there is no cracks intersecting with the sub-internal modification traces 132 between the sub-internal modification traces 132. That is, the internal modification trace 130 is used to adjust the bow value of modified object 100, rather than to split modified object 100.

FIG. 5 is a top view of various internal modification traces of a modified object according to an embodiment of the disclosure, taken using an electron microscope. FIG. 5 shows various internal modification traces 130 formed by using a laser beam L with pulse powers of 0.1 W, 0.3 W, 0.6 W, 1 W, 1.2 W, and 1.5 W, respectively. Referring to FIG. 2B and FIG. 5, in some embodiments, in the top view of the modified object 100, the internal modification trace 130 may include a continuous trace.

FIG. 6 is a bottom-up photograph of various surface processing traces of a modified object according to an embodiment of the disclosure, taken using an electron microscope. FIG. 6 shows various surface processing traces 140 formed by using a laser beam L having pulse powers of 0.1 W, 0.3 W, 0.6 W, 1 W, 1.2 W, and 1.5 W, respectively. Referring to FIG. 2B and FIG. 6, in some embodiments, in the bottom view of the modified object 100, the surface processing trace 140 may include continuous and/or discontinuous traces.

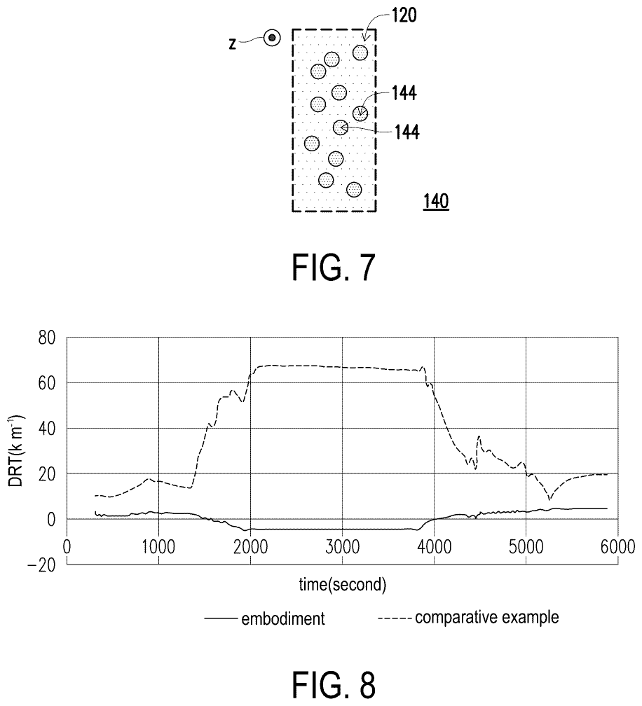

FIG. 7 is a bottom-up and enlarged schematic diagram of a surface processing trace according to an embodiment of the disclosure. Referring to FIG. 7, in some embodiments, at least a portion of the surface processing trace 140 may include a discontinuous trace. In detail, in some embodiments, the surface processing trace 140 includes micro-depressions 144 formed on the second surface 120, and the micro-depressions 144 are spaced apart from each other, such that the surface processing trace 140 appears as a discontinuous trace in a bottom view of the modified object 100. Referring to FIG. 6, in some embodiments, at least a portion of the surface processing trace 140 may include a continuous trace, and the continuous trace may be a micro groove formed on the second surface 120, and the depth of the micro groove thickness direction z is constant.

FIG. 8 shows a DRT curve of a modified object according to an embodiment of the disclosure and a DRT curve of a modified object according to a comparative example. The modified object of the comparative example (not shown) is similar to the modified object 100 of the embodiment, but the difference between the two is that the modified object of the comparative example does not have the internal modification trace 130 and the surface processing trace 140 of the modified object 100 of the embodiment. Referring to FIG. 8, compared with the modified object of the comparative example, the DRT curve of the modified object 100 of the embodiment is gentler. Referring to FIG. 1B, FIG. 2B and FIG. 8, it can be verified that during the heating process of the modified object 100, stress adjustment can be performed inside the modified object 100 through the internal modification trace 130, so as to correct the DRT curve of the modified object 100 during the heating process and improve the warpage problem. The internal modification trace 130 of the modified object 100 helps to control the warpage of modified object 100.

Referring to FIG. 1B and FIG. 2B, in addition, the surface processing trace 140 of the modified object 100 helps to control the temperature rise of the modified object 100. Specifically, during the temperature rise process of the modified object 100, the second surface 120 of the modified object 100 faces the heating source (not shown), and the surface processing trace 140 formed on the second surface 120 can increase the surface roughness of the second surface 120, thereby increasing the thermal resistance of the heating surface (i.e., the second surface 120), thereby controlling the temperature increase conditions of the modified object 100.

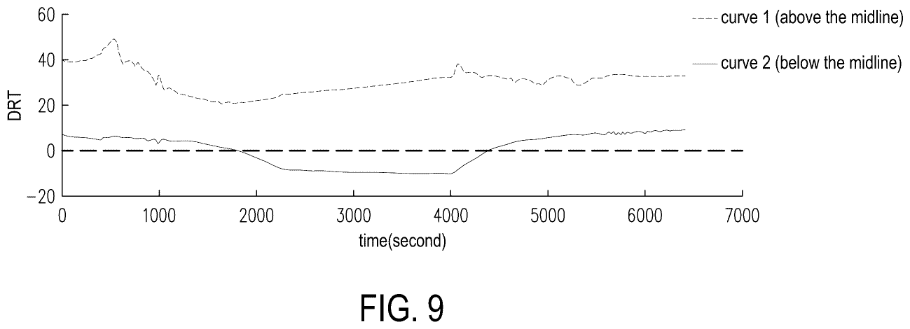

FIG. 9 shows a DRT curve of a modified object of the first embodiment and a DRT curve of a modified object of the second embodiment of the disclosure. The DRT curve 1 of FIG. 9 corresponding to the modified object of the first embodiment is similar to the modified object 100 of FIG. 1B, and the difference between the two is that the internal modification trace 130 of the modified object of the first embodiment is formed between the first surface 110 and the dummy plane P. That is, the internal modification trace 130 of the modified object of the first embodiment corresponding to the DRT curve 1 of FIG. 9 is located above the midline.

The DRT curve 2 of FIG. 9 corresponds to the modified object of the second embodiment. The modified object of the second embodiment can be regarded as the modified object 100 shown in FIG. 1B. The internal modification trace 130 of the modified object of the second embodiment is formed between the dummy plane P and the second surface 120. That is, the internal modification trace 130 of the modified object of the second embodiment corresponding to the DRT curve 2 of FIG. 9 is located below the midline.

Referring to the DRT curve 1 of FIG. 9, forming the internal modification trace 130 between the first surface 110 and the dummy plane P (i.e., above the midline) can make the bow value of the modified object 100 to be positive. Referring to the DRT curve 2 of FIG. 9, forming the internal modification trace 130 between the dummy plane P and the second surface 120 (i.e., below the midline) can make the bow value of the modified object 100 to be negative.

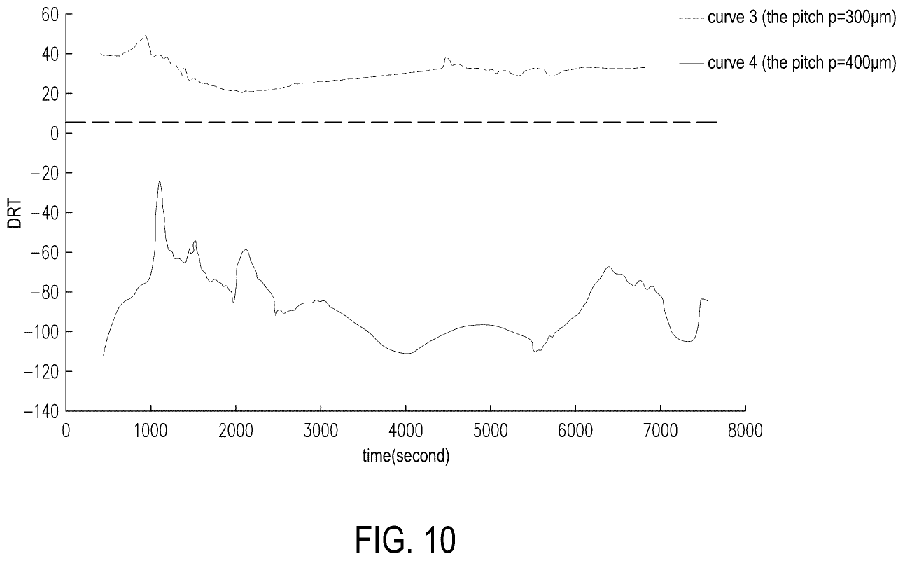

FIG. 10 shows a DRT curve of a modified object according to the third embodiment and a DRT curve of a modified object according to the fourth embodiment of the disclosure. The DRT curve 3 of FIG. 10 corresponds to the modified object of the third embodiment. The modified object of the third embodiment is the same as or similar to the modified object of FIG. 1B. The sub-internal modification traces 132 of the modified object 100 of the third embodiment are arranged at a pitch p in a first direction x perpendicular to the thickness direction z, and the pitch p is equal to 300 μm. The DRT curve 4 of FIG. 10 corresponds to the modified object of the fourth embodiment. The modified object of the fourth embodiment is the same as or similar to the modified object of FIG. 1B. The sub-internal modification traces 132 of the modified object 100 of the fourth embodiment are arranged at a pitch p in a first direction x perpendicular to the thickness direction z, and the pitch p is equal to 400 μm.

Referring to DRT curve 3 of FIG. 10, forming the sub-internal modification traces 132 with a pitch p less than or equal to 300 μm can make the bow value of the modified object 100 to be positive. Referring to DRT curve 4 of FIG. 10, forming sub-internal modification traces 132 with a pitch p greater than 300 μm can make the bow value of the modified object 100 to be negative.

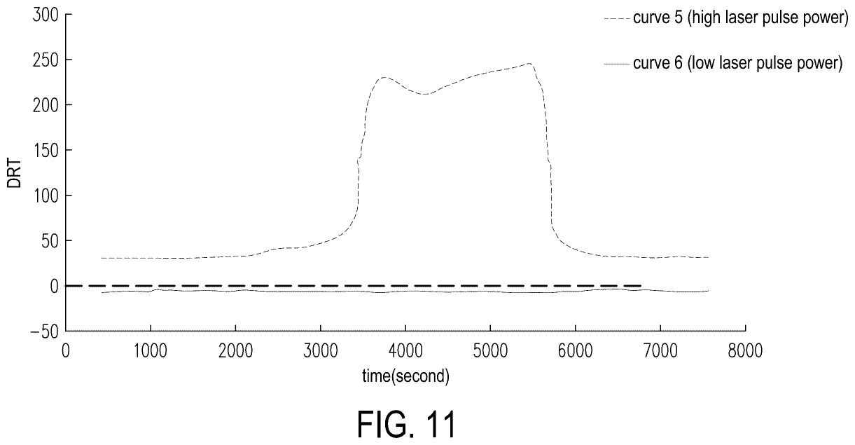

FIG. 11 shows the DRT curve of the modified object of the fifth embodiment and the DRT curve of the modified object of the sixth embodiment of the disclosure. The DRT curve 5 of FIG. 11 corresponds to the modified object of the fifth embodiment. The modified object of the fifth embodiment is the same as or similar to the modified object of FIG. 1B. The internal modification trace 130 of the modified object 100 of the fifth embodiment is formed by using a laser beam L with a high pulse power. The DRT curve 6 of FIG. 11 corresponds to the modified object of the sixth embodiment. The modified object of the sixth embodiment is the same as or similar to the modified object of FIG. 1B. The internal modification trace 130 of the modified object of the sixth embodiment is formed by a laser beam L having a low pulse power.

Referring to DRT curve 5 of FIG. 11, forming the internal modification trace 130 with a laser beam L having a high pulse power can increase the bow value of the modified object 100. Referring to DRT curve 6 of FIG. 11, forming an internal modification trace 130 with a laser beam L having a low pulse power can make the bow value of the modified object 100 to be smaller.

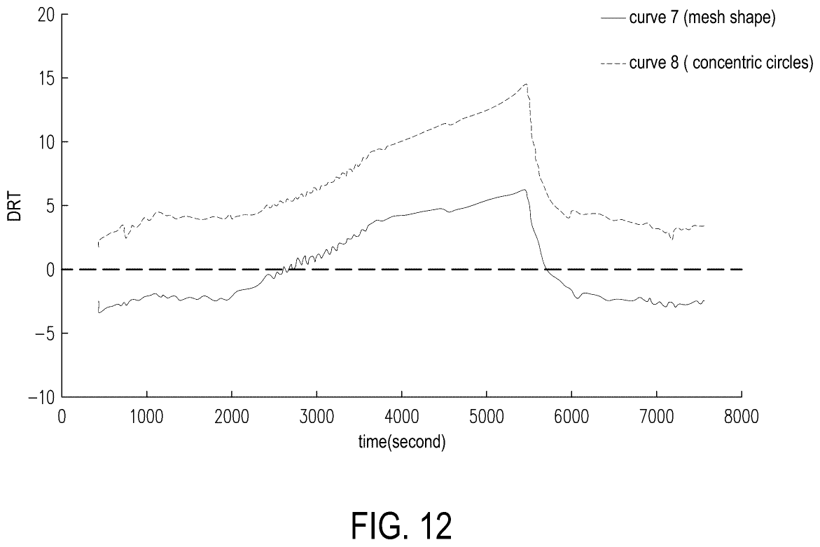

FIG. 12 shows a DRT curve of a modified object according to the seventh embodiment and a DRT curve of a modified object according to the eighth embodiment of the disclosure. The DRT curve 7 of FIG. 12 corresponds to the modified object of the seventh embodiment. The modified object of the seventh embodiment can be viewed as the modified object 100 of FIG. 2B. The internal modification trace 130 and the surface processing trace 140 of the modified object of the seventh embodiment are in a mesh shape. The DRT curve 8 of FIG. 12 corresponds to the modified object of the eighth embodiment. The modified object of the eighth embodiment is the same as or similar to the modified object 100 of FIG. 2B, and the difference between the two is that the internal modification trace 130 and the surface processing trace 140 of the modified object of the eighth embodiment are multiple concentric circles. Referring to DRT curves 7 and 8 of FIG. 12, a suitable predetermined track 112 may be selected according to the bending shape of the object to be modified 100′ to form an internal modification trace 130 and a surface processing trace 140.

In summary, in the manufacturing method of a modified object of an embodiment of the present disclosure, a laser beam is scanned over the object to be modified within a single scanning period to form an internal modification trace inside the object to be modified, and a surface processing trace is formed on the second surface of the object to be modified, thereby completing the modified object. Through the internal modification trace, stress adjustment can be performed internally to correct the bow value of the modified object. Through the surface processing trace, the temperature distribution of the modified object can be controlled when it is heated up.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for manufacturing a modified object, comprising:
providing an object to be modified, wherein the object to be modified comprises a single crystal material, the object to be modified has a first surface and a second surface facing away from the first surface, and the first surface and the second surface of the object to be modified are arranged in a thickness direction of the object to be modified; and
using a laser beam to form a laser spot on the first surface of the object to be modified, and using the laser spot to scan the object to be modified along a predetermined track on the first surface of the object to be modified during a scanning period, so as to form an internal modification trace between the first surface and the second surface of the object to be modified, and form a surface processing trace on the second surface of the object to be modified.

2. The method for manufacturing the modified object as described in claim 1, wherein the internal modification trace is formed synchronously with the surface processing trace.

3. The method for manufacturing the modified object as described in claim 1, further comprising:
setting a working parameter of the laser beam so that a first focal point of the laser beam falls between the first surface and the second surface of the object to be modified, and a again focal point of the laser beam falls on the second surface of the object to be modified.

4. The method for manufacturing the modified object as described in claim 3, wherein the working parameter of the laser beam comprises at least one of a numerical aperture of the laser beam and a pulse power of the laser beam.

5. The method for manufacturing the modified object as described in claim 1, wherein a numerical aperture of the laser beam is in a range of 0.42˜0.65.

6. The method for manufacturing the modified object as described in claim 1, wherein a pulse power of the laser beam is in a range of 0.1 W˜1.5 W.

7. The method for manufacturing the modified object as described in claim 1, wherein a pulse repetition rate of the laser beam is in a range of 100 kHz to 1000 kHz.

8. The method for manufacturing the modified object as described in claim 1, wherein a pulse width of the laser beam is in a range of 10 fs to 5000 fs.

9. The method for manufacturing the modified object as described in claim 1, wherein a central wavelength of the laser beam is in a range of 500 nm to 1100 nm.

10. A modified object, comprising:
a single crystal substrate having a first surface and a second surface facing away from the first surface, wherein the first surface and the second surface of the single crystal substrate are arranged in a thickness direction of the single crystal substrate;
an internal modification trace formed between the first surface and the second surface of the single crystal substrate, wherein the internal modification trace has a depth in the thickness direction; and
a surface processing trace formed on the second surface of the single crystal substrate, wherein the internal modification trace overlaps the surface processing trace in the thickness direction of the single crystal substrate.

11. The modified object of claim 10, wherein the internal modification trace has a first width in a first direction perpendicular to the thickness direction, the surface processing trace has a second width in the first direction perpendicular to the thickness direction, and the second width is smaller than the first width.

12. The modified object of claim 10, wherein a normal projection of the surface processing trace falls within a normal projection of the internal modification trace.

13. The modified object of claim 10, wherein a dummy plane is located between the first surface and the second surface of the single crystal substrate, there is a first distance between the dummy plane and the first surface in the thickness direction, there is a second distance between the dummy plane and the second surface in the thickness direction, the first distance is equal to the second distance, and the internal modification trace is located between the dummy plane and the second surface.

14. The modified object of claim 10, wherein the surface processing trace comprises micro-depressions formed on the second surface, and the micro-depressions are separated from each other.

15. The modified object of claim 10, wherein the surface processing trace comprises a micro groove formed on the second surface, and a depth of the micro groove is constant.

16. The modified object of claim 10, wherein the internal modification trace comprises sub-internal modification traces, the sub-internal modification traces are spaced apart from each other in a first direction perpendicular to the thickness direction, and there is no crack that intersects with the sub-internal modification traces between the sub-internal modification traces.

17. The modified object of claim 10, wherein a dummy plane is located between the first surface and the second surface of the single crystal substrate, there is a first distance between the dummy plane and the first surface in the thickness direction, there is a second distance between the dummy plane and the second surface in the thickness direction, and the first distance is equal to the second distance; the internal modification trace is formed between the first surface and the dummy plane, and a bow value of the modified object is positive.

18. The modified object of claim 10, wherein a dummy plane is located between the first surface and the second surface of the single crystal substrate, there is a first distance between the dummy plane and the first surface in the thickness direction, there is a second distance between the dummy plane and the second surface in the thickness direction, and the first distance is equal to the second distance; the internal modification trace is formed between the dummy plane and the second surface, and a bow value of the modified object is negative.

19. The modified object of claim 10, wherein the internal modification trace comprises sub-internal modification traces, the sub-internal modification traces are arranged at a pitch in a first direction perpendicular to the thickness direction; the pitch is less than or equal to 300 μm, and a bow value of the modified object is positive.

20. The modified object of claim 10, wherein the internal modification trace comprises sub-internal modification traces, the sub-internal modification traces are arranged at a pitch in a first direction perpendicular to the thickness direction; the pitch is greater than 300 μm, and a bow value of the modified object is negative.
